(19) United States
(12) Patent Application Publication
(10) Pub. No.: US 2017/0083884 A1
(43) Pub. Date: Mar. 23, 2017

(54) SYSTEM AND METHOD FOR AUTOMATIC IDENTIFICATION OF PRODUCTS

(71) Applicants: Rami VILMOSH, Kfar Yedidya (IL); Shmuel KOTZEV, Nofit (IL)

(72) Inventors: Rami VILMOSH, Kfar Yedidya (IL); Shmuel KOTZEV, Nofit (IL)

(21) Appl. No.: 14/859,411

(22) Filed: Sep. 21, 2015

(51) Int. Cl. G06Q 20/18; G06Q 20/20; G06K 9/62

(52) U.S. Cl. CPC G06Q 20/18; G06K 9/6215; G06K 9/6202; G06K 9/6281; G06Q 20/208; G06K 2209/17

(57) ABSTRACT

A method for identifying products at a check-out receives sensor inputs sufficient to determine non-image parameters of a product presented by a user for purchase and to provide a sampled image of the presented product. A subset of entries are selected from a database of products available in a store based on matching the non-image parameters of the presented product within a matching tolerance. The sampled image of the presented product is then compared by an image matching process with reference images of the subset of entries retrieved from the database to identify the presented product within the database.

### FIELD AND BACKGROUND OF THE INVENTION

The present invention relates to retail systems and, in particular, it concerns a system and method for automatically identifying products in a retail environment.

Various attempts have been made to provide automated check-out systems which would achieve efficiency and reliability comparable with or exceeding that of a manned check-out. In order to provide a practical solution for an automated check-out, product identification must be achieved in a time of not significantly more than one second per product. Given that a modern supermarket stocks tens-of-thousands of different products, implementation of an effective automated check-out presents major technical challenges.

### SUMMARY OF THE INVENTION

The present invention is a system and method for automatically identifying products in a retail environment.

According to the teachings of the present invention there is provided, a method comprising: (a) providing access to a database containing a set of N entries corresponding to products available in a store, each entry including at least one reference image of a product and at least one non-image parameter characterizing a property of the corresponding product; (b) receiving an input from at least one sensor, the input being sufficient to determine at least one non-image parameter of a product presented by a user for purchase and to provide a sampled image of the presented product; (c) selecting a subset of M entries in the database for which the at least one non-image parameter of the database entry corresponds within a matching tolerance to the non-image parameter of the presented product, where M is less than N; and (d) comparing the sampled image of the presented product within the reference images of the subset of M entries of the database by an image matching process to identify the presented product within the database.

According to a further feature of an embodiment of the present invention, the at least one sensor include a weighing device and at least one camera.

According to a further feature of an embodiment of the present invention, the at least one camera is implemented as at least two cameras deployed for sampling images of the product from different directions.

According to a further feature of an embodiment of the present invention, the at least one non-image parameter includes a shape of the product, and wherein the shape of the product is used to determine from which of the at least two cameras should the sampled image be taken for the image matching process.

According to a further feature of an embodiment of the present invention, the weighing device and the at least one camera are associated with a conveyor arrangement of a check-out so as to measure a weight of a product and sample an image of the product while the product travels along the conveyor arrangement.

According to a further feature of an embodiment of the present invention, the at least one camera is deployed for sampling an image of the product while the product passes through a tunnel with controlled lighting conditions.

According to a further feature of an embodiment of the present invention, the at least one non-image parameter includes a weight of the product and at least one additional non-image parameter selected from the group consisting of at least one dimension of the product; a shape of the product; and a color property of the product.

According to a further feature of an embodiment of the present invention, the at least one additional non-image parameter is a set of parameters including: at least one dimension of the product; a shape of the product; and a color property of the product.

According to a further feature of an embodiment of the present invention, in the event of failing to identify the presented product within the database, an enlarged subset of entries is derived matching the at least one additional non-image parameter without matching the weight and comparing the presented product within the reference images of the enlarged subset of entries of the database by an image matching process to identify the presented product within the database, wherein, in the event of finding a match with incorrect weight, the presented product is flagged as a suspect product.

### BRIEF DESCRIPTION OF THE DRAWINGS

The invention is herein described, by way of example only, with reference to the accompanying drawings, wherein:

FIG. 1 is a schematic isometric view of a check-out system, constructed and operative according to an embodiment of the present invention;

FIG. 2 is a block diagram of the system of FIG. 1;

FIG. 3 is a flow diagram illustrating a method for generating a database of products according to an implementation of the present invention;

FIG. 4 is a flow diagram illustrating a method according to an implementation of the present invention for identifying a product presented by a user; and

FIG. 5 is a flow diagram illustrating further flow of the method of FIG. 4 in the event of failure to identify a product.

### DESCRIPTION OF THE PREFERRED EMBODIMENTS

The present invention is a system and method for automatically identifying products in a retail environment.

The principles and operation of systems and methods according to the present invention may be better understood with reference to the drawings and the accompanying description.

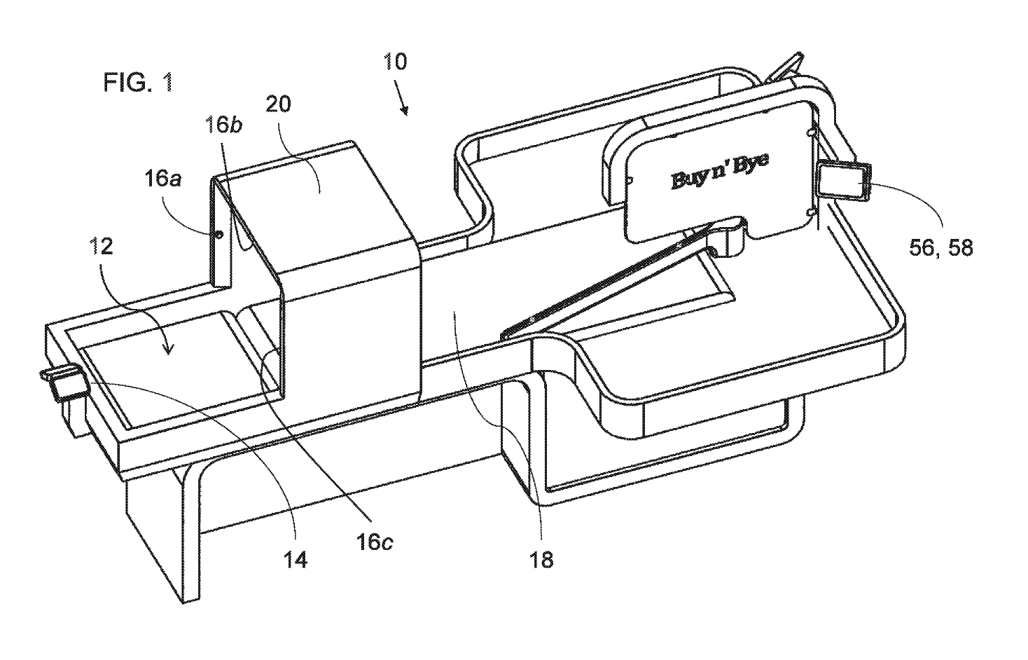

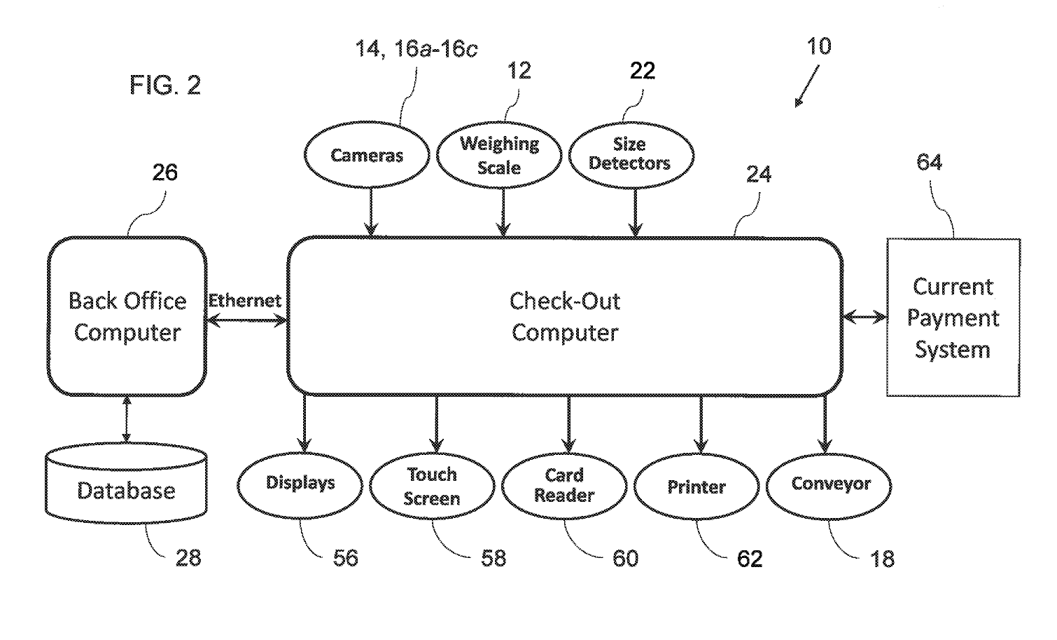

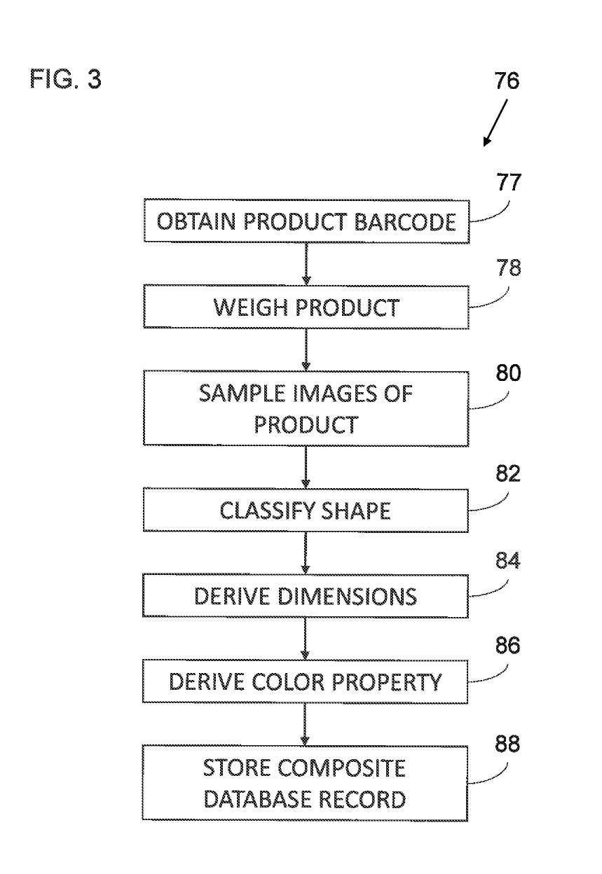

Referring now to the drawings, FIGS. 1 and 2 illustrate an exemplary embodiment of a system for implementing the present invention while FIGS. 3-5 illustrate various aspects of the operation of the system, corresponding to implementations of methods according to the present invention.

The present invention will be illustrated herein in a non-limiting example of an automated self-check-out of a retail store, typically a supermarket. However, it should be appreciated that the principles of the present invention are readily adapted to a range of other applications in which products of many different types must be quickly and reliably identified. The products may be any type of products which are visually distinguishable, such as, in the typical example, food products and other household products.

Referring to FIGS. 1 and 2, there is shown a system, generally designated 10, constructed and operative according to an embodiment of the present invention, for identifying products. In general terms, system 10 includes a weighing device 12 and at least one camera 14, 16a, 16b, 16c, deployed for weighing and sampling images of products presented by a user. Typically, the camera(s) are deployed for sampling images as the products pass along a conveyor 18. Advantageously, weighing device 12 may be implemented as a section of conveyor with an integrated weighing arrangement deployed to feed products onto the main conveyor 18, as seen in FIG. 1. In certain particularly preferred but non-limiting examples, cameras 16a, 16b, 16c are deployed for sampling images of products as they pass on conveyor 18 through a tunnel 20 which provides at least partial regulation of the lighting conditions and background, such as by providing internal tunnel lighting (not shown) and uniform color (for example, plain black or plain white) for the internal wall surfaces of the tunnel. Optionally, light-limiting hanging screens of strips of opaque material (not shown) may further limit penetration of ambient light inside tunnel 20 at one or both sides in order to further standardize the lighting conditions within the tunnel. Optionally, additional size detectors 22 may be deployed to determine at least one dimension of a product passing along the conveyor. One non-limiting example of a size detector may include a vertical array of light-beam sensors deployed within tunnel 20 to determine a maximum height to which a product stands above the surface of the conveyor as it passes. Assuming that the conveyor moves at a known uniform speed, such light-beam sensors can also be used to derive a length of the product along the direction of motion of the conveyor from the time taken for the product to pass.

The various components mentioned above are integrated by connection with a computer system, which may be a distributed system including a local check-out computer 24 in networked communication with one or more centralized computer system of the retail establishment and/or a remote or cloud-based computing system, such as back-office computer 26 and an associated database 28. Each computer typically includes at least one processor, with at least one associated non-volatile data storage device, configured either by software, by hardware design or by a combination thereof, to perform the various processes as described herein, all as will be readily understood by a person ordinarily skilled in the art. The various parts of the computer system are interconnected by suitable wired or wireless communications infrastructure and communicate using standard communications protocols to form a local and/or wide area network. Dedicated, non-standard communications equipment and/or protocols may also be used.

Database 28 may be provided in any suitable data storage device, which may be a local back-office networked storage system operating a RAID array, may be a centralized storage system of a chain of stores located at a remote location, or may be implemented on a cloud server using dynamically allocated resources, all as is known in the art. Database 28 stores a set of N entries corresponding to products available in a store, each entry including at least one reference image of a product and at least one non-image parameter characterizing a property of the corresponding product. The reference imagery and the non-image parameters may be stored in distinct data structures and/or physically separate databases, so long as there is clear one-to-one indexing between them, but are referred to herein functionally as “a database”. Examples of the non-image parameters, and details of a database update process exemplified with reference to FIG. 3, will be discussed below.

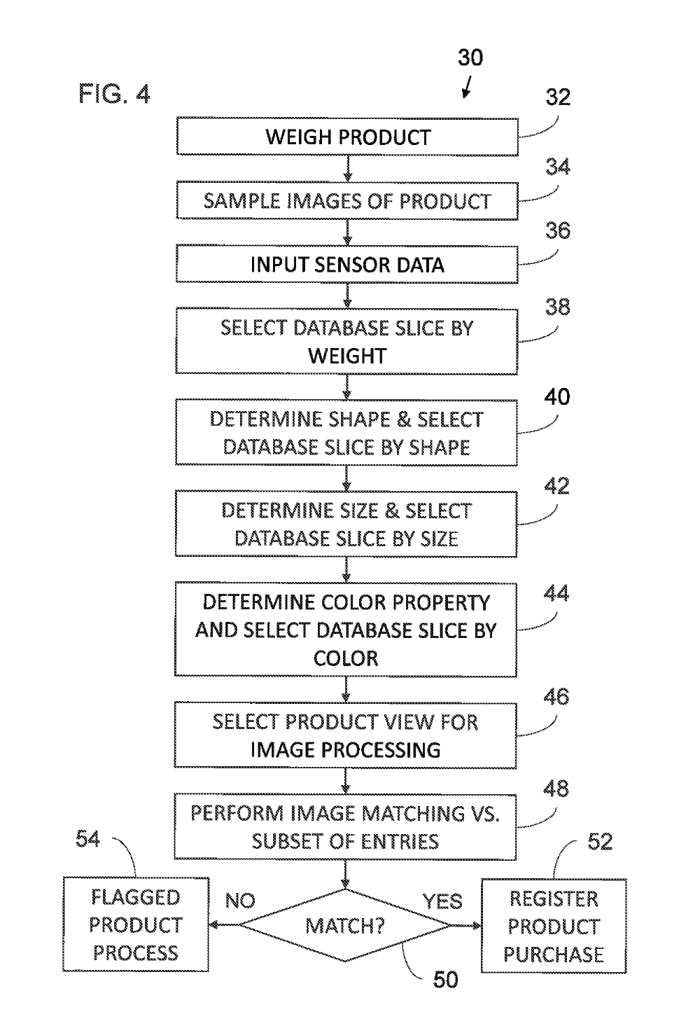

FIG. 4 illustrates the flow of a non-limiting example of the main identification process, generally designated 30, according to an implementation of the present invention. The process starts with various input steps, typically triggered by a user placing a product on the loading region of the conveyor 18, most preferably provided in this case by the conveyor section of weighing device 12. Placing of a product may be identified by sensing the weight change of a product being set down on weighing device 12, or by straightforward image processing based on images from one or more of the cameras with basic object detection and/or optical flow processing. The input steps preferably include weighing of the product (step 32) by weighing device 12, sampling images of the product (step 34) by cameras 14, 16a, 16b and 16c, and inputting any other available sensor data (step 36), such as from size detectors 22. These inputs are then used by the computer system to derive one or more non-image parameter characterizing a corresponding property of the product presented by the user, and hence to narrow down the subset of possibly-relevant database records to which image-matching processing is to be applied.

By way of one non-limiting example, in the flow as illustrated here, at step 38, the system selects a database “slice” considered relevant to the presented product according to weight. The definition of the “slice” takes into account variations that are within normal tolerances of the range of weights of products as well as errors that may occur during the weighing process at the checkout. For example, the relevant slice may be defined as all products in the database having a recorded weight within ±5% of the measured weight. Alternatively, predefined weigh ranges (“slices” or “bands”) may be used. For example, weight bands for products in a typical supermarket may be defined as follows: less than 80 grams; 80-130 grams; 130-180 grams; 180-230 grams; 230-280 grams; 280-380 grams; 380-480 grams; 480-680 grams; 680-740 grams; 740-800 grams; 800-960 grams; 960-1060 grams; 1060-1200 grams; 1200-1450 grams; 1450-1650 grams; 1650-1950 grams; 1950-2100 grams; 2100-2400 grams; 2400-2650 grams; 2650-2900 grams; 2.9-3.2 kg; 3.2-4.9 kg; and more than 4.9 kg.

The width of the bands may be determined by statistical analysis of the weights of products in the database, for example, to place roughly 5% of the products in each band. Thus, certain bands typically cover narrow ranges of weights around common product weights. If a presented product falls within a certain margin of error from the cut-off between two bands, both adjacent bands may be considered candidate products.

In the flow illustrated here, at step 40, the sampled images are processed to determine a shape of the presented product, and a corresponding subset of the database entries is selected. Shape determination may use standard computer vision techniques that do not require heavy processing, and is preferably greatly simplified by defining the task as a classification task, classifying each presented product into one of a relatively small number of predefined shapes. Exemplary shape classifications preferably include, but are not limited to: rectangular box (“cuboid”), cylindrical, bottle (optionally subdivided by neck geometry to distinguish wine bottles, soda bottles, conical-neck bottles), cartons, frustoconical tubs, flat rectangular packages, and a catch-all classification for “other” shapes that do not fall into one of the above classes.

Shaped determination is typically achieved by image processing techniques such as segmentation, to determine the pixels of the images belonging to the presented product (which is greatly simplified by the use of generally uniform backgrounds of the conveyor belt and inside surfaces of the tunnel), outlining to derive silhouettes of the product from different directions, and comparison with shape templates corresponding to each class of shapes to identify a match. The view from camera 16b, i.e., taken downwards from above, is particularly helpful in this process since this direction is typically perpendicular to a major surfaces of the product which it is sitting in contact with the conveyor belt.

The shape classification is used to select a corresponding “slice” of entries from database 28. As with the weight matching, if shape classification is inconclusive between two options, the two shape class options are combined to select a larger shape “slice”.

In a related step 42, preferably performed subsequent to or together with shape determination, one or more size parameter for the presented product is determined, and a corresponding database slice selected. The size parameter may be defined in various ways, and may be derived from dedicated size detectors 22 mentioned above, from the silhouettes derived in the shape determination, or any combination thereof. According to one option, the size parameter is simply the largest measured dimension of the product. Alternatively, a parametric definition may be used including the largest dimension and the smallest dimension, or in some cases, three orthogonal dimensions.

In certain implementations, the size determination may be integrated with the shape classification, benefitting from the determination of product orientation that is typically inherent in the shape classification process. For example, where a shape is classified as a cylinder, the parametric size determination may define an axial length and an outer diameter of the cylinder. In the case of a rectangular cuboid, the parametric definition of size preferably includes all three dimensions measured parallel to the edges of the cuboid. As with the other parameters, a range of values is selected around the measured values sufficient to comfortably encompass product-to-product variations and the degree of precision achieved by the measurement arrangements.

According to a further variation of the size parameter, suitable for implementation independent of, or in the absence of, a shape determination, the size determination may be simply a measurement of the maximum height to which a product stands above the conveyor belt surface. In this case, each product typically has two or three valid size parameters and appears in two or three different “slices”, corresponding to the expected height as would be measured in different orientations of the product. For example, a cylindrical can will be included in the selected group of database entries if the measured maximum height from the conveyor belt corresponds to either the diameter of the can or the axial length of the can.

According to certain particularly preferred implementations as illustrated here, the non-image parameters used for filtering the database entries also include a color property of the presented product. The color property may be variously defined, but is preferably chosen to indicate the predominant color or colors of the product trade dress. According to one non-limiting implementation, the color property may be defined by quantizing the image pixels belonging to the product (according to a segmentation process described above in the context of shape determination) into a relatively small number of colors, such as 256 colors, and then picking out the one or two most prevalent pixel colors in a histogram of the pixel color distribution as a color signature. Alternatively, a full or reduced full histogram of colors associated with pixels belonging to the object in the sampled images may be used as the multi-dimensional “parameter” defining the color property. In cases where a product has different color properties when viewed from different directions, the product may have plural valid color property entries in the database. Here too, where combined with shape determination, the orientation together with the shape determination may be used to enhance the color property determination, for example, disregarding surfaces such as ends of cans which do not typically have distinguishing color properties. Additionally, or alternatively, images or regions of images which have near-uniform color may be disregarded.

The above example has related to each of the non-image properties as independently defining a “slice” of the main database. It should be noted however that this approach is only one of a number of ways to use the non-image properties to derive a reduced-size subset for image matching processing. In a further non-limiting example, each non-image parameter of the presented product may be used with a corresponding distance metric, probability distribution or other function to define a “distance”, “probability” or other measure relating to the degree of match between the presented product and entries in the database. For single value parameters such as weight, the function may be a simple “normal distribution” centered on the measured weight for a “probability distribution”, or an inverted bell curve for a “distance distribution”. For more complex parameters, such as a color histogram derived from a product image, the measure may be a distance in multi-dimensional space defined by any suitable measure. These measures can then be combined, typically with different weights given to the different measures, to derive an overall score for each product database entry as a match for the presented item. The group of M highest scoring entries (a subset of the full database of N entries) are then chosen for subsequent image-matching processing. If no match is found, an additional subset of the next-highest scoring entries may then be processed. This may be repeated until the score from the non-image parameter matching falls below some predefined threshold at which point a no-match result is returned.

It should be noted that the list of non-image parameters listed herein is only exemplary, and various implementations may use a subset of the above non-image parameters, variants of these non-image parameters, additional non-image parameters, and any combination thereof. By way of one additional example, all or part of a barcode visible in a sampled image of a presented product may be searched for and used as a non-image parameter. Clearly, if an entire barcode happens to be visible and legible in an image, this gives positive identification of a product and may be used as a basis to bypass unnecessary steps of the identification process and reduce processing load. Even where only a part of the barcode is visible and legible in the images, this information can be a very helpful non-image parameter in determining a reduced subset of candidate matches within the database for further processing.

Whatever technique is employed, the use of non-image parameters to derive a subgroup of candidate entries drastically cuts down the number of candidate database entries for a give product. In a particularly preferred implementation employing weight, shape, size and color property parameters, a database of tens-of-thousands of product entries is typically cut down to no more than at most a few tens of products which are still candidates for a given presented product. This reduces the subsequent image matching process, which is inherently computationally heavy, to a small-scale task which can be performed rapidly with standard low-cost computing resources at commercially acceptable rates of no more than about 1 second per product, as further detailed below. At step 46, the candidate database entries are identified and the corresponding reference images are retrieved from database 28. Image matching processing 48 is then performed to search for a match for the sampled product images from amongst the candidate database entry reference images.

Image matching can be performed using well known techniques of computer vision which can be implemented using publicly available software modules, such as the Speeded-Up Robust Feature (SURF) algorithm, available in open source version (OpenSURF) written by Chris Evans and available from http://code.google.com/p/opensurf1/. Here too, information regarding the shape and orientation of the presented product obtained during the shape property derivation may be used to select which camera image is suited for use in the image matching process, for example, selecting a side view of a can, bottle or carton. Additionally, or alternatively, data derived from the color property derivation may be used to select which camera image is likely to contain distinctive visual features to facilitate image matching.

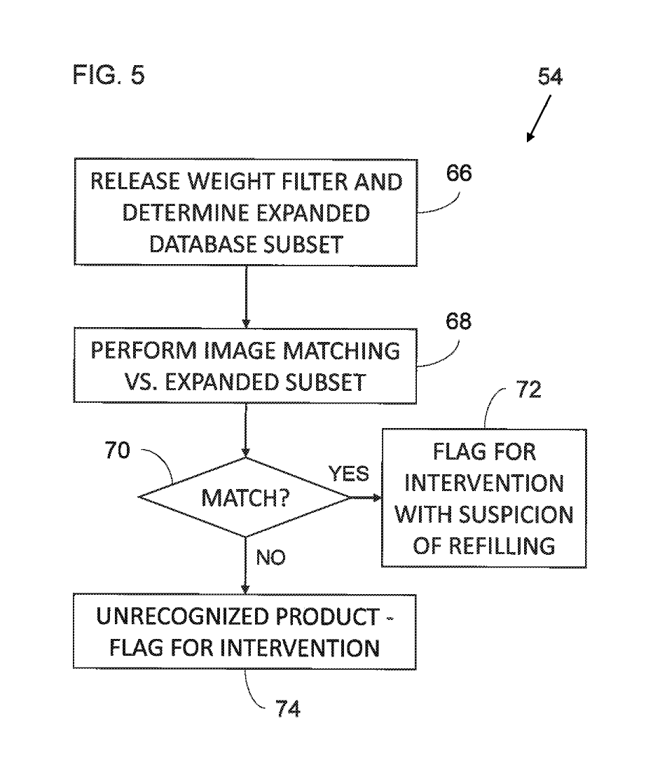

At step 50, if a match is found in the reference images of a database entry, the presented product is identified as the product of the corresponding database entry, and at step 52, purchase of the product is registered in the check-out system. This is the expected outcome for almost all presented products. In the event that image matching fails, i.e., that no acceptable match is found in the reference images of the selected subset of items, process flow is transferred to a flagged product process 54, further detailed in FIG. 5 as discussed below.

The process 30 of FIG. 4 preferably runs repeatedly, typically with temporal overlap between the steps, for processing successive products that are presented by the user by placing them on the set-down area, typically on weighing device 12. Items identified by the system are entered into the automatic check-out register as purchases and the products pass along the conveyor to a packing area. Further processing of the purchase proceeds by interaction with the user via a display 56 and input device, which may be implemented as a touch screen 58 implemented with the display, a card reader 60 for reading credit or debit cards and the like, and a printer 62 for outputting receipts. Additionally, or alternatively, the system may interface with a payment system 64 providing payment options such as bank note identification for cash payments and other forms of electronic payment. The workflow of the check-out, other than the product identification process, is generally similar to a conventional check-out work flow, preferably including presenting to the user the list of products being purchased together with the total cost of the purchase, receiving a suitable form of payment, processing the payment and generating a printed receipt for the user.

A non-limiting example of a flagged-product process 54 according to an implementation of the present invention is illustrated in FIG. 5. According to this implementation, one of the non-image parameter filters is relaxed (broadened) or removed, thereby expanding the candidate subset of product entries defined by the relaxed/remaining parameters, against which images of the presented product are then again compared. In the example illustrated here, at step 66, the weight filter is relaxed. In the example of the “slicing” approach, this may be implemented by including additional slices of weights above and/or below the measured weight, or by completely discarding the weight restriction. In a multi-dimensional distance-function approach, this may be implemented by reducing the weighting factor of the weight measurement or by calculating a score which disregards the weight measurement. Then, at step 68, the image matching comparison step (48 in the main flow of FIG. 4) is repeated against the additional subset of database entries to search for a match. (Clearly, it is not necessary to repeat the comparison against the subset of entries used in the original comparison step 48.) If at 70 a match is found, at step 72 the product is flagged by the system for intervention by staff members with a suspicion of “refilling”. “Refilling” is an increasingly problematic form of theft in which the packaging of a first, low-cost product is emptied out by a thief and replaced with a higher-cost product or products, or where an additional product is inserted into a package together with the original product. In most cases, such refilling will result in a measurable change in the package weight compared to the untampered-with product, while all other characteristic parameters (shape, size, color etc.) and images remain unchanged.

In a further alternative, or additional, variation, a process similar to that of FIG. 5 may be used to gradually expand a narrow initial application of the selection criteria in order to further reduce the processing load of the initial image matching processing. For example, by applying narrower ranges and definitions of the weight, shape, size and/or color parameters to define the “slices” of database entries, it may be possible to get to further reduce the number of candidate entries for image-matching processing, in some cases possibly arriving at a single product or small group of products with for example a 90% overall confidence limit of including the correct product. This would allow roughly 90% of the product identification processes to be performed with enhanced efficiency. In the remaining 10% of cases, the slices would then be expanded in a second iteration to include a larger sample subset for image-matching processing.

If no match is found at step 70, after expansion of the database entry subset, the product is flagged at step 74 for intervention as an unrecognized product. Non-recognition of a product may occur for a number of reasons such as, for example, if the visual appearance of a product has changed significantly from the standard appearance, such as by removal of an outer wrapper of a product or by obscuring of a major part of the surface of the object, such as if a product is presented within an opaque bag or with a plurality of products obscuring each other. Optionally, where temporary impediments such as obscuration or overlap of products is likely, the user may be presented with notification and/or instructions on how to try to re-present the product, for example, removing visual obscurations or spatially separating products, in order for the automated recognition process to succeed. Non-recognition may also occur in cases where a new product is stocked or where an existing product packaging has been changed by the manufacturer without the database having been timely updated.

In cases of flagging of a product for intervention, a human customer service assistant is typically called, either physically present at the check-out or via intercom and video conferencing from a back-office location. Particularly where there may be a concern of refilling, or any other concern of intentional misuse of the system, a customer service assistant physically present is preferred. However, it is expected that the frequency of flagging for intervention will be sufficiently low to allow a low ratio of attendants to check-outs. As in all retail environments, video monitoring of the check-out process to watch for intentional foul-play is recommended.

Practically, products flagged for intervention may optionally be returned towards the beginning of the conveyor by stopping and reversing the direction of the conveyor. Alternatively, in order to minimize interruption to the check-out process, the process may continue normally while flagging images of the unidentified product(s) as queries which must be resolved and approved by a member of staff prior to completion of the check-out process.

Turning now to FIG. 3, this illustrates schematically the flow of a process 76 for creating and updating database 28. The process includes obtaining the product's barcode 77, for example using a barcode scanner, weighing of the product 78, sampling images of the product 80, classifying the shape of the product 82, deriving dimensions of the product 84, deriving a color property of the product 86, and storing a composite database record containing non-image parameters characterizing a property of the product and at least one associated reference image of the product. Details of each of these processes will be clear by analogy to the corresponding parameters of the identification as discussed above, and will not be discussed further here.

The hardware required for creating and updating the database is conceptually parallel to the hardware of the check-out system, requiring weighing and imaging from various directions and various processing to derive the parameters to be stored in the database entry. Practically, the database entry input system benefits from a more controlled environment, and allows the operator to select particularly preferred directions for sampling images of the product most likely to be useful in the identification process. A conveyor is not required, and a single camera can be used sequentially to sample the required images. A keyboard or barcode reader may be used to identify the product within the inventory system and the data and sampled images derived from the product are then be used to automatically generate a new database entry, or to update or supplement an existing entry with a new appearance of an existing product, for example, after a change to the graphics of the product packaging.

Optionally, the registration process may be repeated for a number of samples of a given product, thereby allowing statistical analysis to assess the range of variation in the measured parameters between different samples. This statistical analysis may then be used to set confidence limits determining how narrowly each parametric slice can be defined for each product. For example, a product with very narrow variations in weight between samples may only need to appear in a single weight “slice” whereas a product of the same average weight but with larger variance may require inclusion in two or more adjacent weight “slices”. The sampled images may also be stored together with the results of the identification process for subsequent offline analysis (investigation, quality control etc.).

Additionally, or alternatively, the system may implement a learning process according to which, after positive identification of a product during check-out, the associated parameters are employed for statistical analysis, for example, in the manner described above, to allow further refinement of the database records and/or to optimize the definitions of the parameters defining the slices.

Although the primary example described herein refers to matching of sampled product images to reference images from the database, it should be noted that the reference images in the database may not be simple images, but may instead be three-dimensional models of the products with associated textural information. This allows generation of a reference image of the product from any desired viewpoint, thereby in some cases making the image matching process more robust. Technology for generating three-dimensional models of objects is well known, and will not be described herein. In most cases, use of a database containing one or more two-dimensional reference image of each product is believed to be sufficient, and to simplify the processing in both the database update procedure and the check-out procedure.

It will be appreciated that the above descriptions are intended only to serve as examples, and that many other embodiments are possible within the scope of the present invention as defined in the appended claims.

What is claimed is:

1. A method comprising:
(a) providing access to a database containing a set of N entries corresponding to products available in a store, each entry including at least one reference image of a product and at least one non-image parameter characterizing a property of the corresponding product;
(b) receiving an input from at least one sensor, said input being sufficient to determine at least one non-image parameter of a product presented by a user for purchase and to provide a sampled image of the presented product;
(c) selecting a subset of M entries in the database for which said at least one non-image parameter of the database entry corresponds within a matching tolerance to the non-image parameter of the presented product, where M is less than N; and
(d) comparing the sampled image of the presented product within the reference images of the subset of M entries of the database by an image matching process to identify the presented product within the database.

2. The method of claim 1, wherein said at least one sensor include a weighing device and at least one camera.

3. The method of claim 2, wherein said at least one camera is implemented as at least two cameras deployed for sampling images of the product from different directions.

4. The method of claim 3, wherein said at least one non-image parameter includes a shape of the product, and wherein said shape of the product is used to determine from which of said at least two cameras should the sampled image be taken for the image matching process.

5. The method of claim 2, wherein said weighing device and said at least one camera are associated with a conveyor arrangement of a check-out so as to measure a weight of a product and sample an image of the product while the product travels along the conveyor arrangement.

6. The method of claim 5, wherein said at least one camera is deployed for sampling an image of the product while the product passes through a tunnel with controlled lighting conditions.

7. The method of claim 1, wherein said at least one non-image parameter includes a weight of the product and at least one additional non-image parameter selected from the group consisting of: at least one dimension of the product; a shape of the product; and a color property of the product.

8. The method of claim 7, wherein said at least one additional non-image parameter is a set of parameters including: at least one dimension of the product; a shape of the product; and a color property of the product.

9. The method of claim 7, further comprising, in the event of failing to identify the presented product within the database, deriving an enlarged subset of entries matching said at least one additional non-image parameter without matching the weight and comparing the presented product within the reference images of the enlarged subset of entries of the database by an image matching process to identify the presented product within the database, wherein, in the event of finding a match with incorrect weight, the presented product is flagged as a suspect product.
